(19) United States
(12) Patent Application Publication
(10) Pub. No.: US 2002/0070971 A1
(43) Pub. Date: Jun. 13, 2002

(54) System and methods for tracking central office equipment and inventory records

(76) Inventors: Terrence A. Brown, Burtonsville, MD (US); Reginald E. Waters, Washington, DC (US)

Correspondence Address: Greenberg Traurig, LLP, 12th Floor, 1750 Tysons Boulevard, McLean, VA, 22102, US

(21) Appl. No.: 09/973,066

(22) Filed: Oct. 10, 2001

Related U.S. Application Data
(60) Provisional application No. 60/238,522, filed on Oct. 10, 2000.

(51) Int. Cl. G09G 5/00

(52) U.S. Cl. 345/775

(57) ABSTRACT

A system and methods for tracking central office equipment and inventory records comprised of a series of modules to provide access to link drawings, racks and equipment across an entire network infrastructure. The system and methods provide a user the ability to view equipment, group equipment, and search for equipment and available rack space. Additionally, the central office equipment and inventory records can be compiled into reports for engineering, planning and analysis.

This application is related to and claims the benefit of provisional application 60/238,522 filed Oct. 10, 2000, the teachings of which are hereby incorporated herein in their entirety, including all appendices. This application includes a microfiche appendix having 1 fiche of 39 frames each. The teachings contained on the fiche are incorporated herein by reference in their entirety.

### BACKGROUND OF THE INVENTION

1. Field of the Invention

The invention relates to the field of telecommunications, and more specifically, to a system and methods for tracking central office equipment and inventory records.

2. Background

Various patents disclose methods for detecting feature interaction in telecommunication networks. U.S. Pat. No. 6,198,811 B1 issued Mar. 6, 2001 to Klose et al. discloses a system and method for downloading data from purchases of telephone services. This data can then be associated automatically with the purchaser for billing purposes. U.S. Pat. No. 6,185,519 B1 issued Feb. 6, 2001 to Lin et al. discloses a method and system for feature interaction detection in a telecommunication network to disclose potential problems between various types of telecommunications equipment. The teachings of these patents are herein incorporated by reference.

None of the two listed patents monitor the overall management of the central office. This would include all equipment residing in the central office, whether it's a diesel engine, telephone switch, or a distributing frame. In addition, these shortcomings address primarily the management of the network, but not the equipment that runs the network. Furthermore, these patents all provide support involving accessing the central office, in order to update the snapshot of the current network equipment infrastructure or engineering drawings.

There exists a need wherein a central processing unit (CPU) can be accessed by a database program for the purposes of inventory, asset management and financial accounting of central office telecommunications equipment. It is desirable to view, track and analyze central office equipment and the racks residing across an entire telecommunications infrastructure via the Internet, eliminating the need to visit the central offices which are often a large distance from the engineers, planners and accountants. A need also exists to track the life cycle of all central office equipment. To save space within current central office buildings and meet the demand for colocation space for competitors resulting from the Telecommunications Act of 1996, accurate information regarding telecommunications equipment is needed.

Objects of the Invention

Accordingly, several objects of the present invention for a system and methods for tracking central office equipment and inventory records are:

a) A primary object of the invention is to provide a method to involve a graphical user interface (GUI) for a user to interact and access a database, allowing the user to view the central office equipment and inventory records, central office drawings and equipment details, including asset and financial information.

b) Another object of the invention is to provide a method to track central office equipment and inventory records within a central processing unit (CPU) that can be accessed by a database program for the purposes of accessing inventory, asset management and financial accounting of central office equipment.

c) Another object of the invention is to provide a method to conduct network planning at the central office, based upon the ability to know exactly what resides within each central office, via the Internet.

d) A further object of the invention is to provide a method to track the equipment, providing various types and levels of equipment details.

e) Yet another object of the invention is to provide a method to track the life cycle of central office equipment and inventory records, whether it is new, retired or moved, throughout the central office.

f) Still yet another object of the invention is to provide a method to group central office equipment, by equipment type.

g) Another object of the invention is to provide a method to integrate central office equipment and drawings together, thereby eliminating the need to travel to the central office to view equipment.

h) Another object of the invention is to provide a method to view all racks within a central office via the Internet.

i) A further object of the invention is to provide a system that can restrict access between users, departments, or companies.

j) Yet another object of the invention is to provide a system to provide asset placement within an network infrastructure by central offices (or data centers), rows (or aisles), racks (or data cabinets), and equipment (or assets).

k) Still yet another object of the invention is to provide a system to be updated and revised to generate reports for asset management, depreciation and other accounting procedures for financial purposes.

l) Another object of the invention is to provide a system to search (or query) within a database program for user-friendly access to rack and equipment placement for specific central office equipment and inventory records via the Internet.

m) Another object of the invention is to provide a system to track central office equipment and inventory records within a central processing unit (CPU) that can be accessed by a database program for the purposes of inventory, asset management and financial accounting of central office equipment.

Other objects and features of the present invention will become apparent from the following descriptions, taken in connection with the accompanying drawings, wherein, by way of illustration and example, an embodiment of the present invention is disclosed.

Advantages of the Invention

Accordingly, the system and methods for tracking telecommunications central office equipment and inventory records can be used to easily access and view equipment records without requiring the need to travel to these rural or remote central offices. In addition, the system and methods have additional advantages in that they:

provide for the ability to search (or query) the database for the purposes of finding various record data for maintenance purposes;

provide for the ability to view, save and conduct light markup of central office drawings off-line;

provide for the ability for multiple users to view drawings at the same time for engineering and planning purposes;

provide for the ability to move laterally from a “drawing to racks” and “racks to drawing” interchangeably;

provide for the ability to easily update the database via forms seamlessly transferring data directly into the database;

provide for the ability to be accessed by wireless application protocols (WAP) via a cellular phone and/or personal digital assistant.

Although the description above contains many specificities, these should not be construed as limiting the scope of the invention but merely providing illustrations of some of the presently preferred embodiments of this invention. Thus, the scope of the invention should be determined by the appended claims, rather than by the examples given.

### SUMMARY OF THE INVENTION

A system and method for tracking telecommunications central office equipment and inventory records comprising a series of modules to provide access to link, view, group, search, and report central office information (drawings, racks, equipment) across an entire network infrastructure.

A system for tracking telecommunications central office equipment information includes a database of telecommunications equipment information for a central office, a management report generator for extracting and providing reports on the equipment contained in a central office, a search engine for responding to queries of the entire database of telecommunication equipment information, a graphical user interface for providing visual representations of equipment within a central office, and a drawing system interfacing with the graphical user interface and the database for viewing, printing and editing drawings depicting central office equipment.

### BRIEF DESCRIPTION OF THE DRAWINGS

The accompanying drawings, which are included to provide a further understanding of the invention and are incorporated in and constitute a part of this specification, illustrate an embodiment of the invention and together with the description serve to explain the principles of the invention.

FIG. 1 is a screenshot illustrating the home and log in page.

FIG. 2 is a screenshot illustrating the “About Cenotrack” page.

FIG. 3 is a screenshot illustrating the Main Menu page.

FIG. 4 is a screenshot illustrating the Drawing Search page.

FIG. 5 is a screenshot illustrating the Rack Search page.

FIG. 6 is a screenshot illustrating the Equipment Search page.

FIG. 7 is a screenshot illustrating the Reports Search page.

FIG. 8 is a screenshot illustrating the Search Results page.

FIG. 9 is a screenshot illustrating the Search Results detail page.

FIG. 10 is a screenshot illustrating the Drawing page.

FIG. 11 is a screenshot illustrating the frontal view of a rack.

FIG. 12 is a screenshot illustrating the Rack Details page.

FIG. 13 is a screenshot illustrating the Log Out page.

FIG. 14 is a diagram illustrating the detailed rack configuration

FIG. 15 is a block diagram illustrating the flow of the present invention.

FIG. 16 is a high-level flow chart of the operation of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

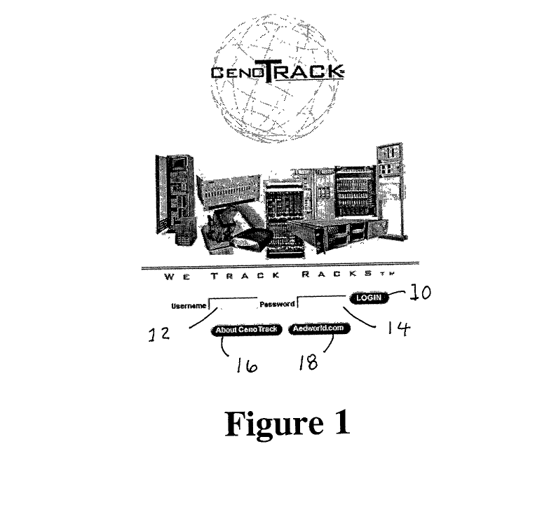

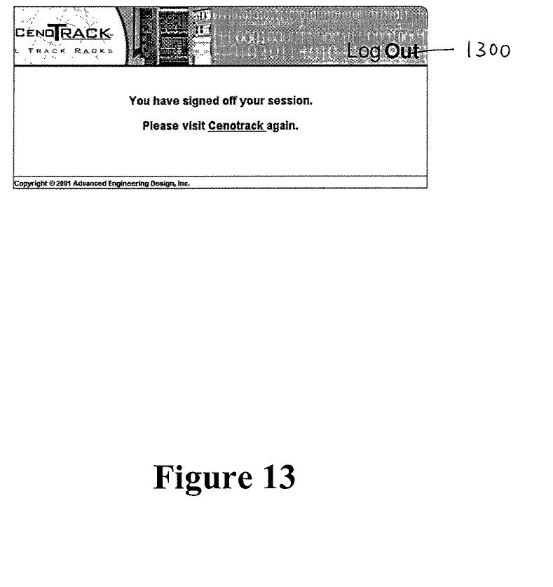

A preferred embodiment of the system and methods for tracking central office equipment and inventory is illustrated in FIG. 1 as the home/login screen. FIG. 1 shows the start of the computer program which provides a login 10, username 12 and password protection 14 for entering the Cenotrack web site. If the login, username and password information is incorrect, the user is sent to the FIG. 13 log out screen. Additionally, as shown in FIG. 1, the user may find out information about CenoTrack 16 or about Advanced Engineering Design, Inc. 18 by clicking on the appropriate buttons.

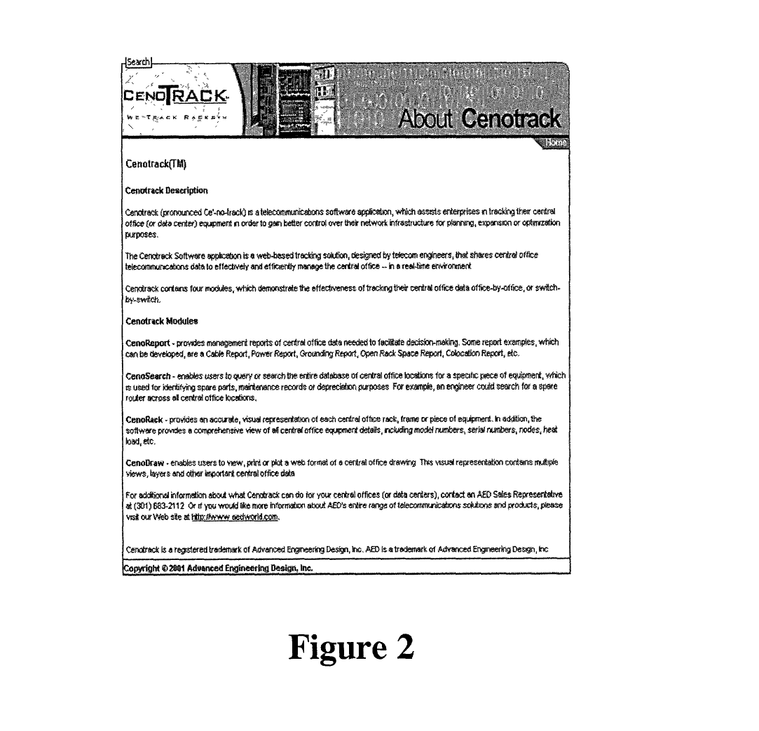

FIG. 2 discloses information about the present invention including reports, searching, rack information, and drawings changes that can be made in using the present invention. Information can be gained without having Internet access to the CenoTrack web site.

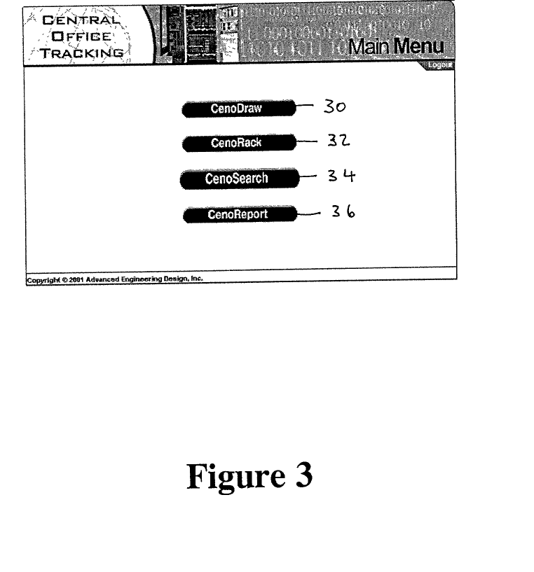

If the login is successful, the user is brought to the main menu screen shown in FIG. 3 containing four application modules. CenoDraw 30 enables users to view, print or plot a web format of a central office drawing. This visual representation contains multiple views, layers and other important central office data. CenoRack 32 provides an accurate, visual representation of each central office rack, frame or piece of equipment. In addition, the software provides a comprehensive view of all central office equipment details, including model numbers, serial numbers, nodes, heat load, etc. CenoSearch 34 enables users to query or search the entire database of central office locations to a specific piece of equipment, which is used for identifying spare parts, maintenance records or determining depreciation value. CenoReport 36 provides management reports of central office data needed to facilitate decision-making. Some report examples, which can be developed are Cable Report, Power Report, Grounding Report, Open Rack Space Report, Colocation Report, etc. From the FIG. 3 screenshot, the user has the ability to retrieve central office equipment and inventory reports in a format that is user friendly. The method increases the productivity of the user by simplifying engineering work flow and financial and accounting functions.

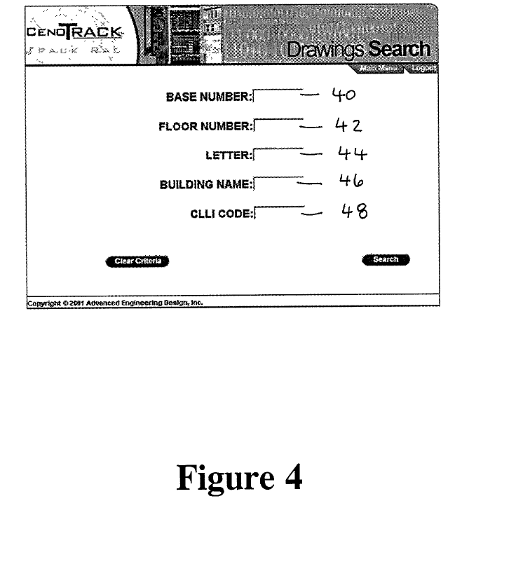

In an example, the user has the ability to retrieve central office drawings by clicking on CenoDraw 30. This sends the user to the FIG. 4 drawing search screen for input of data. The user is required to input a base number 40 or any other information such as floor 42, letter 44, along with building name 46 or common language location identifier (CLLI) 48. Upon entry to known information, the user can then query the database and retrieve a multitude of central office drawings and floors. The information can be narrowed by specific letters or CLLI codes to pinpoint the desired data.

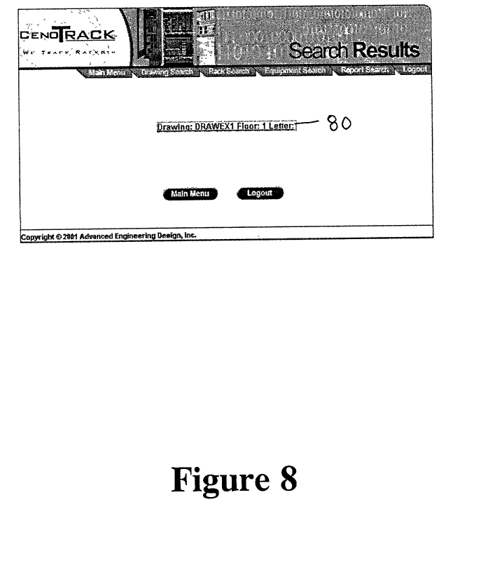

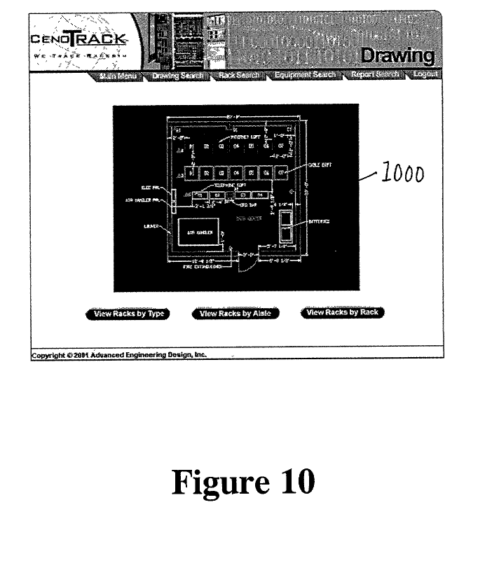

A drawing search according to FIG. 4 results in a select number of drawings presented on the search results screen illustrated in FIG. 8. By clicking on the search results 80, the drawing can be viewed with a free downloadable program, such as Autodesk Voloview Express 2, as shown in FIG. 10. Once within the screen illustrated in FIG. 10, the drawing of the central office showing the racks and isles can be panned. The user may scroll on the drawing and zoom in and out for greater detail.

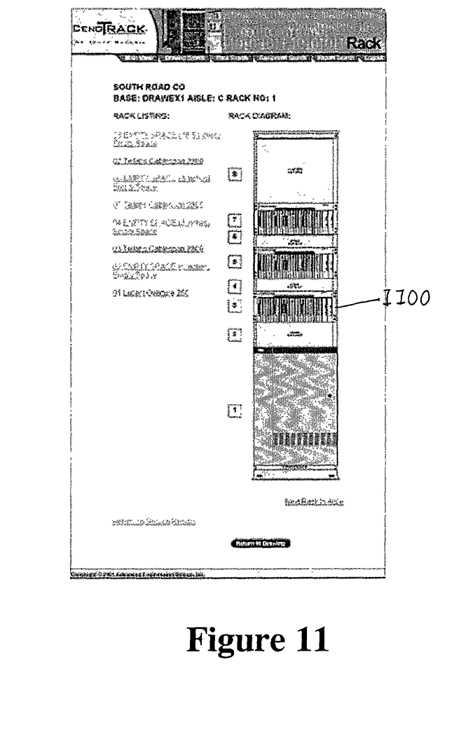

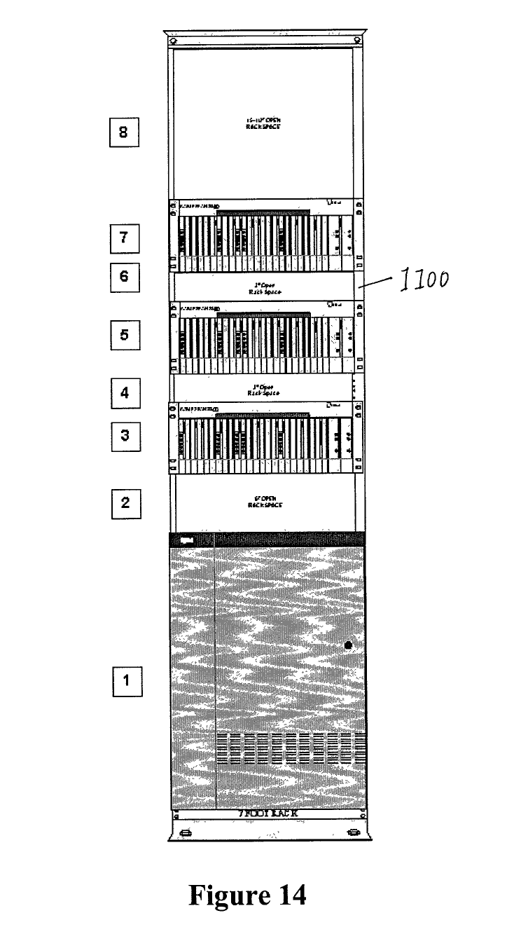

By clicking on a portion of FIG. 10, an individual piece of equipment such as a rack, may be retrieved such as that shown in FIG. 11. FIG. 11 shows a two-dimensional view of a rack including filled and unfilled positions. As a matter of convention, the lowest position is the one closest to the bottom of the rack. An important feature of the present invention is the ability to link racks to the drawing 1000 by the user. By clicking within the rack drawing, the user is presented with a view of the two-dimensional representation of the rack as illustrated in FIG. 14.

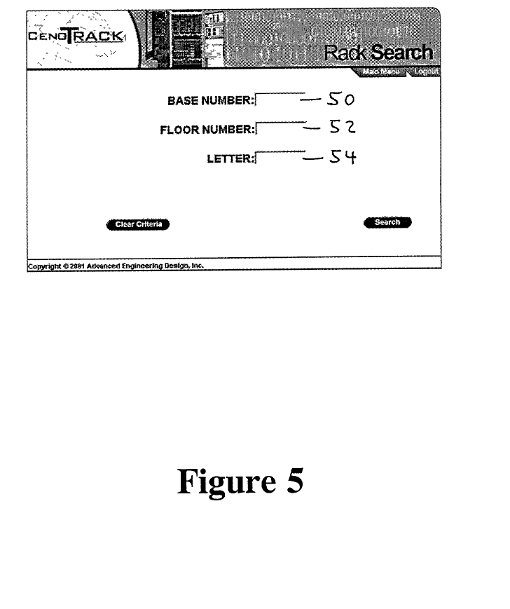

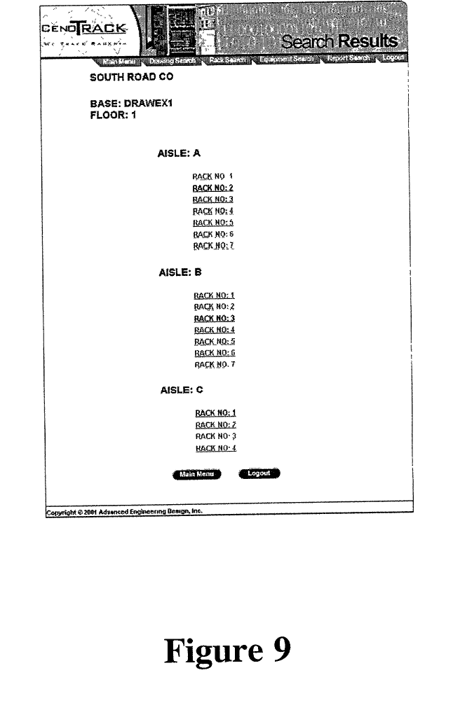

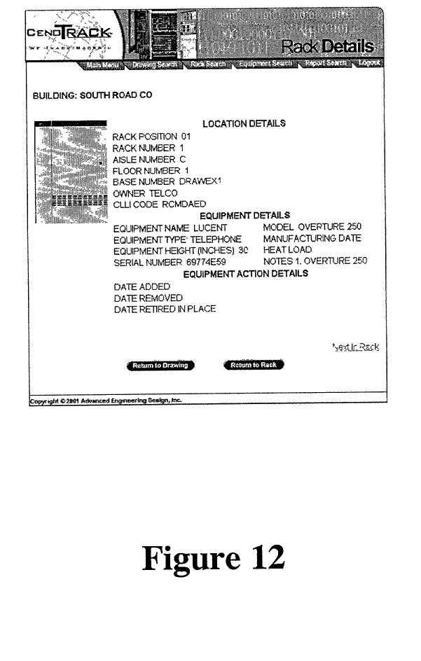

In another example of the operation of the invention, the user has the ability to retrieve central office equipment rack information by clicking CenoRack 32 as shown in FIG. 3. This brings up the screen illustrated in FIG. 5. Once the user inputs base number 50, floor number 52 or letter 54, the database is queried to produce one or more drawings as shown in FIG. 9. From the drawings retrieved during the search, a detail of the rack is uncovered as shown in FIG. 12.

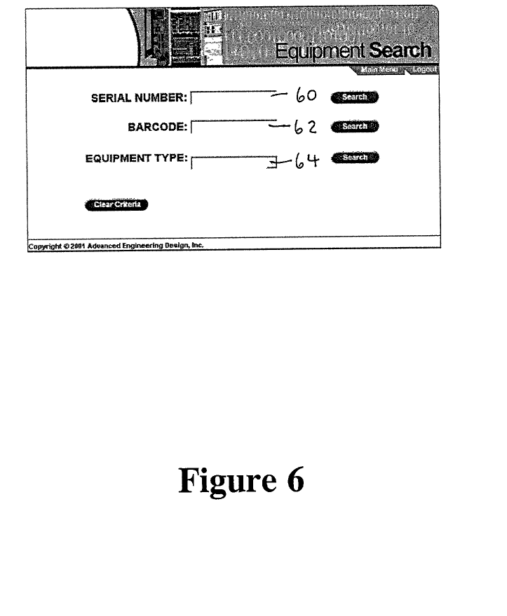

FIG. 3 provides the user the ability to retrieve specific central office equipment information, including equipment details bypassing the drawing of Figure 10 and the rack shown in FIG. 11. By clicking on CenoSearch 34, the user is sent to FIG. 6 to input data. The user is requested to input either the serial number 60, barcode 62 or the equipment type 64. This sends the user to the equipment details of the central office equipment shown in FIG. 12, bypassing the search results screen FIG. 8.

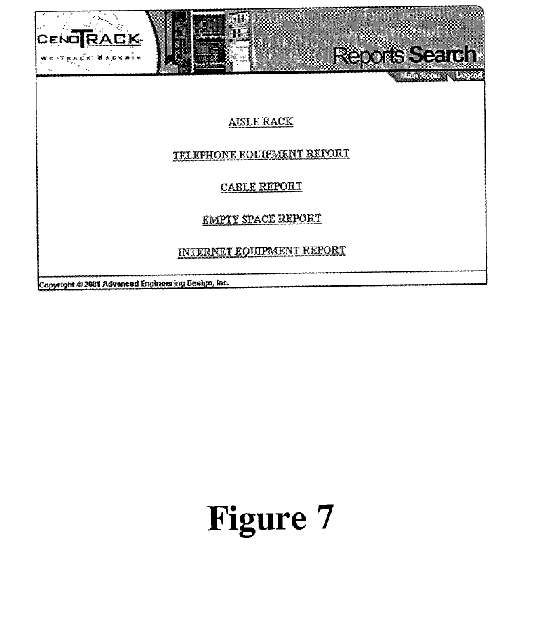

FIG. 3 provides the user the ability to retrieve predefined reports of central office equipment inventory, including transport, power, colocation, and open space, allowing the user to view reports based upon an entire central office inventory records. By clicking on CenoReport 36, the user is sent to FIG. 7 to retrieve the desired reports. Predefined reports may include aisle rack, telephone equipment, cable, empty space and Internet equipment reports.

Throughout every figure screen, (FIG. 1 to FIG. 13), the user can click the log out button 1300, in order to log out from the CenoTrack site.

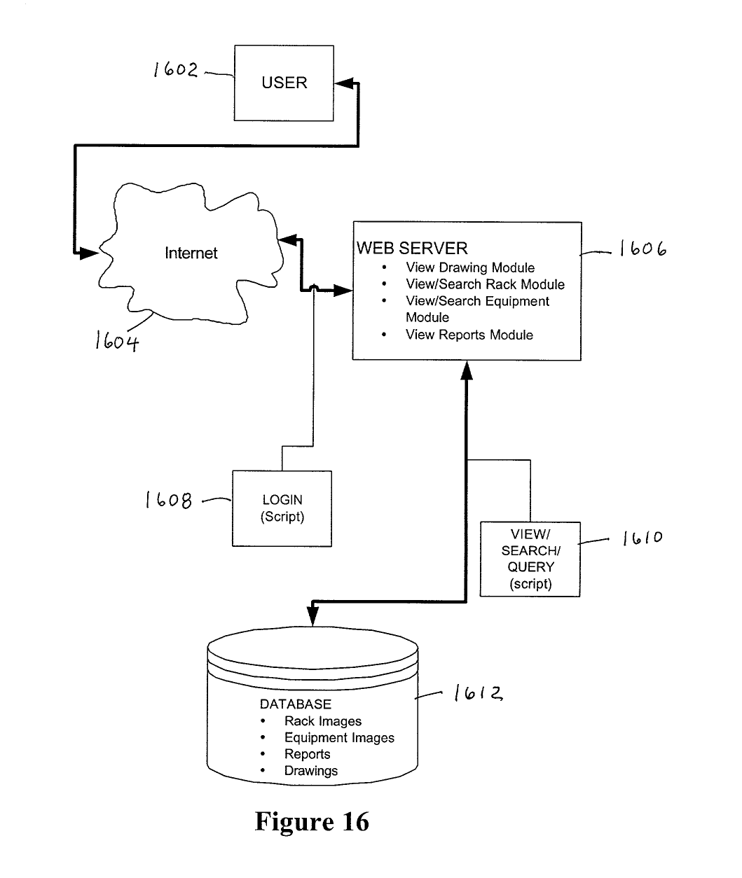

Illustrated in FIG. 16 is the overall architecture of the present invention. A user 1602 logs in through Internet 1604 to a web server 1606. If the login script 1608 is verified, the user may use the web server to view drawing modules, to search rack modules, to search for equipment or to generate reports. The web server 1606 interfaces with a database 1612 through search query script 1610. The database contains rack images, equipment images, reports and drawings.

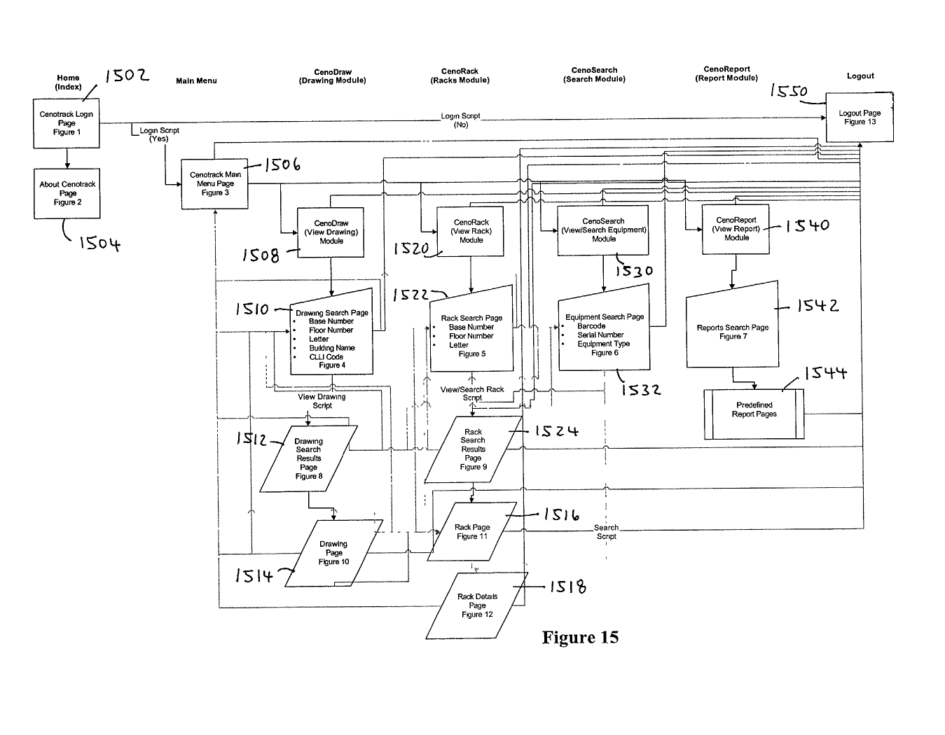

The process flow of the present invention is illustrated in block diagram form in FIG. 15. From the login screen 1502, the user can obtain information about CenoTrack in box 1504 or log onto the CenoTrack main menu 1506. From the main menu, a user may choose CenoDraw 1508 to perform a drawing search step1510, which can be obtained from entry of a base number, floor number, letter, building name, or CLLI code. The drawing search results 1512 lead to the actual drawing 1514. The actual drawing can be panned, scrolled or zoomed to the desired location.

By selecting a portion of the drawing shown in FIG. 10, a link to the corresponding rack is made in step 1516 and which is displayed in FIG. 11. Rack details 1518 can then be displayed as shown in FIG. 12.

If CenoRack 1520 is chosen from the main menu, the rack search page 1522 is presented. By entering base number, floor number or letter as shown in FIG. 5, the rack search results 1524 are presented as shown in FIG. 9. More detailed information can be obtained from rack page 1516 and rack details 1518.

When choosing CenoSearch 1530 from the main menu, a search for equipment can be made. In step 1532 the equipment search page is presented for user input of serial number, barcode and equipment type. The query results in the rack search or in the rack detail page depending upon the input information.

Selection of CenoReport 1540 from the main menu brings up a view report module. A report search page 1542 illustrated in FIG. 7 contains predefined reports 1544 which may be chosen as desired.

At any time throughout the use CenoTrack, the log out feature 1550 may be chosen to end the session.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for tracking central office telecommunications equipment information, comprising:
a database of telecommunications equipment information for a central office;
a graphical user interface for providing access to the database and visual representations of equipment information within a central office;
a search engine for responding to user queries of the database of telecommunication equipment information;
a management report generator for extracting and providing reports on the equipment contained in a central office based on the results of a search engine query; and
a drawing system interfacing with the graphical user interface and the database for viewing, printing and editing drawings depicting central office equipment.

2. The system of claim 1 wherein the access to the database is through the Internet.

3. The system of claim 1 wherein the visual representation allows a drawing to be panned, zoomed and scrolled.

4. The system of claim 3 wherein a link is established between the visual representation of the drawing and the equipment including rack details.

5. The system of claim 1 wherein types of equipment and inventory records contained in the database are accessed and reported as a group.

6. The system of claim 1 wherein position number is used to organize display of racks and equipment in a visual representation.

7. The system of claim 1 wherein access to the central office telecommunications equipment information is restricted by security controls on users.

8. The system of claim 1 wherein access to the database is through a wireless application protocol.

9. A method of tracking central office telecommunications equipment information, comprising the steps of:
storing telecommunications equipment information for a central office in a database;
providing access to the database and visual representations of equipment information within a central office through a graphical user interface;
searching the database of telecommunication equipment information in response to a user query;
extracting and providing management reports on the equipment information contained in a central office based on the query search results; and
interfacing with the graphical user interface and the database for viewing, printing and editing drawings depicting central office equipment.

10. The method of claim 9 wherein access to the database is through the Internet.

11. The method of claim 9 wherein a drawing may be manipulated by panning, zooming and scrolling.

12. The method of claim 9 wherein a link is established between the visual representation of a drawing and the equipment including rack details.

13. The method of claim 9 wherein the types of equipment and inventory records contained in the database are accessed and reported as a group.

14. The method of claim 9 wherein position number is used to organize display of racks and equipment in a visual representation.

15. The method of claim 9 wherein access to the central office telecommunications equipment information is restricted by security controls on users.

16. The method of claim 9 wherein access to the database is through a wireless application protocol.

17. A computer program product for tracking central office telecommunications equipment information comprising:
a computer useable medium having a computer readable program code means embodied in the computer usable medium for causing an application program to execute on a computer system, the computer readable program code means comprising:
computer readable program code for storing a database containing telecommunications equipment information for a central office;
computer readable program code for providing access to the database and visual representations of equipment information within a central office.
computer readable program code for querying the database for information based on a user request;
computer readable program code for visually presenting the results of the query in the form of reports; and
computer readable program code for allowing the viewing, printing and editing of drawings depicting central office equipment.

18. The computer program product of claim 17 wherein the database is accessed through the Internet.

19. The computer program product of claim 17 wherein the database is accessed through a wireless application protocol.

20. The computer program product of claim 17 wherein access to the central office telecommunications equipment information is restricted by security controls on users.
